(19) United States
(12) Patent Application Publication
(10) Pub. No.: US 2018/0036197 A1
(43) Pub. Date: Feb. 8, 2018

(54) VARIABLE PRESSURE MASSAGE APPARATUS

(71) Applicant: Hassan A. Khansari, Downey, CA (US)

(72) Inventor: Hassan A. Khansari, Downey, CA (US)

(21) Appl. No.: 15/226,241

(22) Filed: Aug. 2, 2016

(51) Int. Cl. A61H 15/02; A61H 15/00

(52) U.S. Cl. CPC A61H 15/02; A61H 15/0078; A61H 2201/0207; A61H 2201/0221; A61H 2015/0014; A61H 2201/1215; A61H 2203/0475

(57) ABSTRACT

Disclosed herein is a variable pressure massage apparatus including a position adjustable table upon which an individual lays to receive a massage without the presence of a masseuse or a masseur. Standing above the position adjustable table are a motor housing in which a heating lamp and a motor are located and from which a rotating massage drum is suspended and held above the table. The motor is coupled to a spindle of the rotating massage drum by way of a reduction gear box that is located within the motor housing so that a force generated by the motor causes the massage drum to rotate. The massage drum has a plurality of interchangeable rollers which roll over the body of the individual to administer the massage as the massage drum is rotated by the motor.

### BACKGROUND OF THE INVENTION

### 1. Field of the Invention

This invention relates to a variable pressure massage apparatus including a position adjustable table upon which an individual lays to receive a massage. The apparatus also includes a motor housing and a motor driven massage drum that is suspended from the motor housing and held above the position adjustable table at which to be rotated so as to apply a pressure primarily for massaging the hips of an individual to reduce or distribute fat and cellulite.

### 2. Background Art

The health and therapeutic advantages of a massage are well known. Typically, an individual seeking a massage lies on a stationary massage table. In some cases, the massage is primarily intended to reduce or redistribute fat and cellulite at and near the hips of the individual. A masseuse or a masseur applies a pressure with his hands or a hand-held device to deliver the massage to the individual. Because delivering the massage to the individual requires the intervention of a masseuse or a masseur, the individual must first find a skilled therapist and then cither travel to the therapist's work site or have the therapist visit the individual. Moreover, because the therapist will tire, the length of the massage is limited in its duration. Likewise, the cost to the individual to receive the massage can become expensive with the frequency of the massages and the skill of the therapist. In this same regard, the therapist may not always be available to fit the schedule of the individual.

What would therefore be desirable is a massage apparatus which can be stationed in a gym, a therapy center or in the home of an individual seeking a massage and include a table on which the individual will lay so that the massage can be delivered to the hips and adjacent areas of the individual on an as-needed basis without the intervention of a masseuse or a masseur and without limitation as to the duration or regularity of the massage.

### SUMMARY OF THE INVENTION

In general terms, a variable pressure massage apparatus is disclosed which includes a rotating massage drum having a generally cylindrical configuration and a position adjustable table located below the massage drum upon which an individual lays to receive a massage without the intervention of a masseuse or a masseur. The apparatus includes a hollow stand within which a lift is slidably received. A user actuated pedal is located adjacent the position adjustable table to be activated by the individual laying on the table to cause the lift to slide through the stand. The lift is connected to the table so that a movement of the lift relative to the stand causes a corresponding movement of the table and the individual laying thereon relative to the rotating massage drum.

A motor housing stands upwardly and above the position adjustable table. The rotating massage drum is suspended from the motor housing so as to be held over the individual laying on the table. An electric motor and a reduction gear box are located within the motor housing. The motor generates a rotational force which is applied to the rotating massage drum by way of the reduction gear box and a spindle which extends outwardly through the motor housing to the massage drum. The rotating massage drum includes a plurality of interchangeable rollers that are carried by and rotatable around respective roller shafts so as to roll over the body and particularly the hips of the individual to administer the massage when the massage drum is rotated by the motor. As a modification, the plurality of rollers are mounted on shafts that are offset from the longitudinal axes of the rollers to cause the rollers to vibrate as the drum rotates so as to more effectively reduce and redistribute the fat of the individual.

An electric heal lamp is located within the motor housing so as to lie above the rotating massage drum. Heat that is generated by the heat lamp is applied to the massage drum to heat the rollers thereof by way of an open window formed in the motor housing.

### BRIEF DESCRIPTION OF THE DRAWINGS

FIG. 1 shows a variable pressure massage apparatus according to a preferred embodiment of this invention including a position adjustable table so that an individual lying on the table can receive a massage at and near her hips so as to reduce or distribute fat and cellulite;

FIG. 2 shows details of a motor housing and a generally cylindrical rotating massage drum that is suspended from the motor housing and held above the position adjustable table of the massage apparatus of FIG. 1;

FIG. 3 shows an enlarged detailed view of the rotating massage drum that is suspended from the motor housing of FIG. 2;

FIG. 4 is a front view of the rotating massage drum shown in FIG. 3 having a plurality of interchangeable rollers to roll over the body and hips of the individual shown in FIG. 1;

FIG. 5 illustrates a first embodiment for one of the plurality of interchangeable rollers from the rotating massage drum of FIG. 4;

FIG. 6 illustrates a second embodiment of one of the plurality of interchangeable rollers from the rotating massage drum of FIG. 4;

FIG. 7 illustrates a third embodiment for one of the plurality of interchangeable rollers from the rotating massage drum of FIG. 4; and

FIG. 8 represents a modification of the generally cylindrical rotating massage drum wherein the plurality of rollers that are shown in FIG. 4 are mounted on and rotatable around shafts that are offset from the longitudinal axes of the rollers.

### DESCRIPTION OF THE PREFERRED EMBODIMENT

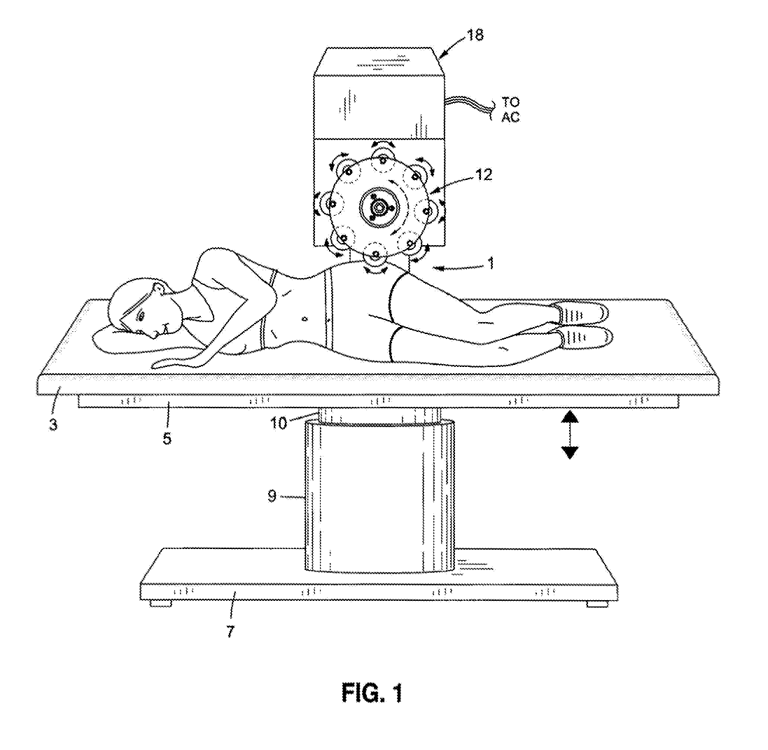

A variable pressure massage apparatus 1 according to a preferred embodiment of this invention is initially described while referring to FIG. 1 of the drawings. The massage apparatus 1 includes a position adjustable table 3 that can be located in a gym, at home or in a therapy center to support the weight of an individual seeking the benefits of a massage without the intervention of a masseuse or a masseur. In the case of FIG. 1, a woman is shown laying on her side so that a massage pressure can be applied primarily to her hip for the purpose of reducing or redistributing fat and cellulite, receiving massage therapy, or simply for her comfort. However, it is to be understood that the individual with whom the massage apparatus 1 is used is not limited to a woman, and the area to be treated is not limited to the individual's hip, as shown, and may extend to other areas of her body including the thighs, chest, stomach and legs.

The position adjustable table 3 is ideally a hard foam pad that is covered by vinyl, leather or the like. A sheet (not shown) may be placed over the table 3 upon which the individual will lay while receiving a massage. The table 3 rests on and is supported by a (e.g., wooden) platform 5. Laying on the ground and spaced below the table 3 is a base 7. A hollow cylindrical stand 9 is affixed at the bottom thereof to the base 7. The opposite top end of the cylindrical stand 9 is open. A cylindrical lift 10 is located within and slidable through the hollow cylindrical stand 9. The top of the lift 10 is affixed to the bottom of the table platform 5. The position of the lift 10 within the stand 9 is manually controlled by the individual so as to selectively adjust the individual's position relative to a generally cylindrical rotating massage drum 12 of the massage apparatus 1 by which a massage pressure to be applied to the user can be correspondingly controlled. Electrical and mechanical means are well known in the art for causing the lift 10 to move through the stand 9 by which to cause a corresponding movement of the position adjustable table 3 relative to the massage drum 12.

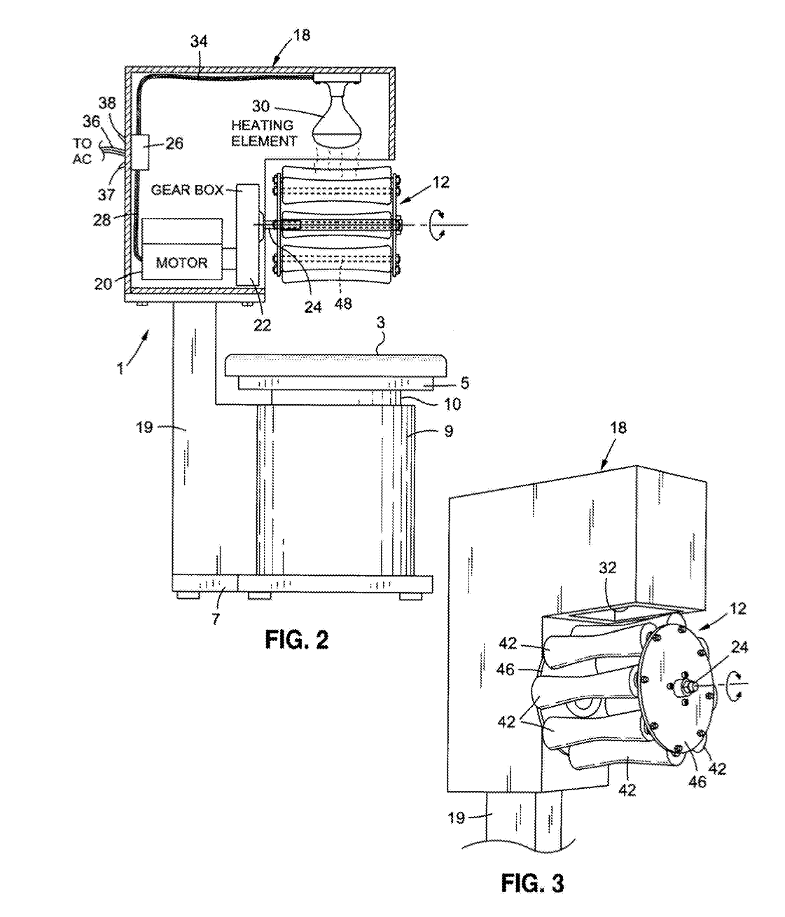

Referring concurrently to FIGS. 1-3 of the drawings, details are provided of a motor housing 18 of the variable pressure massage apparatus 1. The motor housing 18 is held above the position adjustable table 3 by a mount 19 that stands upwardly from the base 7 of apparatus 1. The motor housing 18 is preferably manufactured from metal and encloses a motor 18. By way of example, the motor 18 is a ½ horsepower electric motor that is coupled to the rotating massage drum 12 by way of a 1750:25 reduction gear box 22 (best shown in FIG. 2). In particular, a rotatable spindle 24 which extends axially through the massage drum 12 is connected to the gear box 22 through the motor housing 18 so that a driving force generated by the motor 20 is imparted to the massage drum 12 at the spindle 24 to cause a rotation of the massage drum. At the same time, the connection of the spindle 24 to the gear box 22 enables the rotating massage drum 12 to be suspended outside the motor housing 18 and held above the individual laying on the position adjustable table 3. The massage drum 12 is rotated by the motor 20 at an ideal speed of 25 RPM to massage a hip of the individual laying on the table 3 in a manner that will soon be explained.

The motor 20 is connected to one side of an electrical switch box 26 by way of an electrical wire 28. The switch box 26 and an electrical heating lamp 30 are both located inside the motor housing 18. The heating lamp 30 is mounted within the motor housing 18 so as to be held above an open window 32 or similar opening formed in the motor housing (best shown in FIG. 3). The open window 32 formed in the motor housing 18 lies above the rotating massage drum 12 so that the heat generated by the lamp 30 is transmitted through the window 32 to the massage drum 12 by which the massage drum is heated. The heating lamp 30 which, for example, provides 250 watts of power is connected by way of an electrical wire 34 to the opposite side of the switch box 26 inside motor housing 18.

The switch box 26 is connected by way of an electrical power cord 36 to an electrical wall socket or any other suitable source of AC power. The switch box 26 has two external switches 37 and 38 that are accessible outside the motor housing 18. Closing a first switch 37 enables AC power to be provided to the motor 20. Closing the second switch 38 enables AC power to be applied to the heating lamp 30.

Details of the generally cylindrical rotating massage drum 12 that is suspended from the motor housing 18 so as to lie above the position adjustable 3 of the variable pressure massage apparatus 1 are now explained while referring concurrently to FIGS. 2-7 of the drawings. The massage drum 12 includes a plurality of (e.g., eight) interchangeable (e.g., wooden) rollers 42 that are uniformly spaced from one another in a circumferential direction around the rotatable spindle 24 (best shown in FIGS. 2 and 3). The rollers 42 are also uniformly spaced radially outward from the spindle 24.

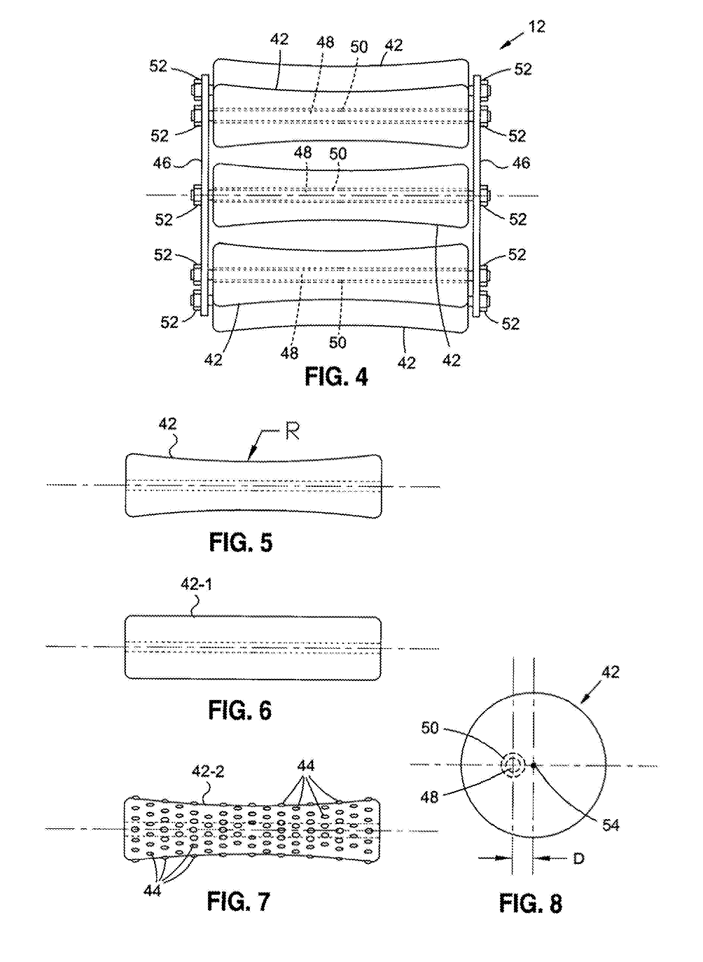

By way of a first example, the drum rollers 42 may be radiused along the length thereof (best shown in FIGS. 4 and 5). A radiused drum roller configuration is preferable so as to conform to the curves in the hip of the individual being massaged. By way of a second example, the drum rollers (designated 42-1 in FIG. 6) may be uniformly cylindrical along their length. A cylindrical drum roller configuration is preferable for applying a uniformly firm pressure to the individual being massaged. By way of another example, the drum rollers (designated 42-2 in FIG. 7) may have a radiused configuration (like that shown in FIG. 5) and include a plurality of nubs or dimples 44 projecting therefrom. The nubs 44 enable focused points of pressure to be applied to the individual being massaged.

The rotating massage drum 12 has a pair of disk-shaped side plates 46 that are spaced from one another. The spindle 24 which extends from the motor housing 18 runs longitudinally through the generally cylindrical rotating massage drum 12 so as to extend between and outwardly from the side plates 46. The plurality of rollers 42 also extend between the opposing side plates 46 so as to surround the spindle 24. Each roller 42 has an axial bore 50 and a shaft 48 that runs longitudinally through the bore (best shown in FIG. 4). The roller shafts 48 are of sufficient length to extend outwardly past the pair of side plates 46 between which the rollers 42 extend. The opposite ends of the roller shafts 48 are threaded, and correspondingly threaded fasteners (e.g., nuts) 52 are mated thereto to hold the shafts 48 and the rollers 42 through which the shafts 48 extend in place between the side plates 46 of the massage drum 12 (also best shown in FIG. 4). Removing the fasteners 52 allows the interchangeable rollers 42 to be replaced by different rollers.

The diameter of each of the roller shafts 48 is less than the diameter of the respective bores 50 through which the shafts 48 ore received, such that each roller 42 is rotatable around its shaft 48 when the rollers are pressed against and moved over the body of the individual being massaged. At the same time, the massage drum 12 and the rollers 42 that are carried thereby are rotated by the motor 20 at the spindle 24 so as to generate a pressure to be applied to the individual being massaged (best illustrated in FIG. 1). The rollers 42 are heated by the heat that is generated by the heating lamp 30 (of FIG. 2) and applied to drum 12 via the open window 32 (of FIG. 3) formed in the motor housing 18.

A modification to the rotating massage drum 12 of FIGS. 1-4 is shown in FIG. 8 of the drawings. In this case, the shafts 48 which extend between the opposing side plates 46 and around which the rollers 42 rotate are offset by a distance “D” form the longitudinal axes (designating the point 54) of the rollers. The distance “D” is ideally about 1/16 inch. By virtue of this offset, a vibration is introduced to the plurality of rollers 42 that are carried by the shafts 48 of the massage drum 12 as the drum rotates. Accordingly, the pressure that is applied to the individual by the massage apparatus 1 of this invention may advantageously be more effective to reduce or redistribute the individual's fat during the massage.

1. An apparatus for massaging an individual, said apparatus comprising:
a table upon which the individual lays when receiving the massage;
a rotatable massage drum having at least one roller to apply a pressure to the individual laying on the table to administer the massage, said rotatable massage drum positioned above the table so as to engage the body of the individual; and
a motor coupled to said rotatable massage drum to generate a force to be imparted to said rotatable massage drum to cause said massage drum to rotate and said at least one roller thereof to roll over the body of the individual receiving the massage.

2. The apparatus recited in claim 1, further comprising a motor housing within which said motor is located, said rotatable massage drum located outside said motor housing and coupled to said motor through said motor housing such that said rotatable massage drum is suspended from said motor housing and held above said table.

3. The apparatus recited in claim 2, further comprising a reduction gear box located within said motor housing and coupled between said motor located within said motor housing and said rotatable massage drum located outside said motor housing.

4. The apparatus recited in claim 2, further comprising a heat source located within said motor housing and positioned above the rotatable massage drum suspended from said motor housing, said heat source generating heat to be applied to said rotatable massage drum to heat the at least one roller thereof.

5. The apparatus recited in claim 4, wherein said heal source is an electric healing lamp, said motor housing having an opening formed therein, and said electric heating lamp being located within said motor housing and generating the heat to be applied by way of said opening to said rotatable massage drum located outside said motor housing.

6. The apparatus recited in claim 2, wherein said motor housing stands upwardly and above said table such that said rotatable massage drum is suspended from said motor housing and held over said table.

7. The apparatus recited in claim 1, wherein said rotatable massage drum includes first and opposite sides that are spaced from one another, such that the at least one roller of said rotatable massage drum extends between said first and opposite sides, said rotatable massage drum also including a spindle connected to said motor located within said motor housing and extending outwardly from said motor housing and through the first and opposite sides of said rotatable massage drum located outside said motor housing so that the force generated by said motor is imparted lo said rotatable massage drum by way of said spindle to cause said massage drum to rotate.

8. The apparatus recited in claim 7, wherein said rotatable massage drum includes a plurality of rollers, each of said plurality of rollers being mounted on and rotatable around a respective shaft that extends between the first and opposite sides of said rotatable massage drum.

9. The apparatus recited in claim 8, wherein the shafts that extend between the first and opposite sides of said rotatable massage drum and around which said plurality of rollers rotate are offset from the longitudinal axes of said plurality of rollers.

10. The apparatus recited in claim 8, wherein each of said plurality of rollers has a rediused body extending along the length thereof between the first and opposite sides of said rotatable massage drum.

11. The apparatus recited in claim 8, wherein each of said plurality of rollers has a cylindrical body extending along the length thereof between the first and opposite sides of said rotatable massage drum.

12. The apparatus recited in claim 8, wherein each of said plurality of rollers has a set of pressure focusing nubs projecting outwardly therefrom.

13. The apparatus recited in claim 1, wherein the position of said table on which the individual lays to receive the massage is adjustable relative to said rotatable massage drum.

14. The apparatus recited in claim 13, further comprising a hollow stand and a lift slidably received by said hollow stand and connected to said table, said lift being slidable through said hollow stand in order to adjust the position of said table relative to said rotatable massage drum.
